(19) United States
(12) Patent Application Publication
(10) Pub. No.: US 2026/0065650 A1
(43) Pub. Date: Mar. 5, 2026

(54) DATA-EFFICIENT VISUAL INSTRUCTION TUNING FOR MULTIMODAL LARGE LANGUAGE MODELS

(71) Applicant: Honda Motor Co., Ltd., Tokyo (JP)

(72) Inventors: Faizan SIDDIQUI, Santa Clara, CA (US); Shao-Yuan LO, Milpitas, CA (US); Bardia SAFAEI, Baltimore, MD (US)

(21) Appl. No.: 19/169,848

(22) Filed: Apr. 3, 2025

Related U.S. Application Data
(60) Provisional application No. 63/688,128, filed on Aug. 28, 2024.

(51) Int. Cl. G06V 10/774; G06V 10/762; G06V 30/19

(52) U.S. Cl. CPC G06V 10/774; G06V 10/762; G06V 30/19107; G06V 30/19147

(57) ABSTRACT

According to one aspect, instruction tuning may include generating a set of instructions for a reference set of images selected from a set of images based on one or more task specific instruction generation protocols, generating one or more task importance weights for the reference set of images based on the set of instructions and the reference set of images and a ratio of a first loss of a first loss function associated with a response and an image from reference set of images and a second loss of a second loss function associated with the response, a question, and the image from reference set of images, and generating a set of instructions for a remaining set of images from the set of images based on one or more of the task importance weights, k-means clustering, and neighbor centrality from a cluster of the k-means clustering.

### CROSS-REFERENCE TO RELATED APPLICATIONS

This application claims the benefit of U.S. Provisional Patent Application, Ser. No. 63/688,128 (Attorney Docket No. H1242048US01) entitled “DATA-EFFICIENT VISUAL INSTRUCTION TUNING FOR MULTIMODAL LARGE LANGUAGE MODELS”, filed on Aug. 28, 2024; the entirety of the above-noted application(s) is incorporated by reference herein.

### BACKGROUND

Generally, visual instruction tuning (VIT) utilizes a multi-modal model to extract features from image and text components in visual instruction-following data. This model generally includes a vision encoder and a large language model (LLM) as its core components. However, a major challenge often overlooked is that generating instructions from unlabeled images for VIT may be computationally expensive. Most existing VIT datasets rely heavily on human annotations or paid services like Generative Pre-trained Transformer (GPT), which limits users with constrained resources from creating VIT datasets for custom applications.

### BRIEF DESCRIPTION

According to one aspect, a system for instruction tuning may include a processor and a memory. The memory may store one or more instructions. The processor may execute one or more of the instructions stored on the memory to perform one or more acts, actions, and/or steps. The processor may generate a set of instructions for a reference set of images selected from a set of images based on one or more task specific instruction generation protocols. The processor may generate one or more task importance weights for the reference set of images based on the set of instructions and the reference set of images and a ratio of a first loss of a first loss function associated with a response and an image from reference set of images and a second loss of a second loss function associated with the response, a question, and the image from reference set of images. The processor may generate a set of instructions for a remaining set of images from the set of images based on one or more of the task importance weights, k-means clustering, and neighbor centrality from a cluster of the k-means clustering.

One or more images of the set of images may be associated with one or more tasks. One or more of the tasks may be an optical character recognition (OCR) recognition task, a recurring expression detection task, or a conversation capability task. The processor may calculate the first loss and the second loss by feeding an image of the reference set of images through a vision encoder, a projector, and a large language model (LLM). The processor may calculate the first loss or the second loss by feeding the question and the response of the set of instructions through a tokenizer and a large language model (LLM). The processor may generate one or more of the task importance weights for the reference set of images based on task-wise averaging the ratio of the first loss and the second loss. The processor may perform k-means clustering based on one or more of the task importance weights and one or more visual features from the remaining set of images. The processor may generate one or more of the visual features for the remaining set of images based on an encoder. Each instruction for the set of instructions may include a corresponding question and a corresponding response. The processor may perform fine-tuning on a large vision language model (LVLM) based on the set of instructions for the remaining set of images.

According to one aspect, a computer-implemented method may include generating a set of instructions for a reference set of images selected from a set of images based on one or more task specific instruction generation protocols, generating one or more task importance weights for the reference set of images based on the set of instructions and the reference set of images and a ratio of a first loss of a first loss function associated with a response and an image from reference set of images and a second loss of a second loss function associated with the response, a question, and the image from reference set of images, and generating a set of instructions for a remaining set of images from the set of images based on one or more of the task importance weights, k-means clustering, and neighbor centrality from a cluster of the k-means clustering.

One or more images of the set of images may be associated with one or more tasks. One or more of the tasks may be an optical character recognition (OCR) recognition task, a recurring expression detection task, or a conversation capability task. The computer-implemented method may include calculating the first loss and the second loss by feeding an image of the reference set of images through a vision encoder, a projector, and a large language model (LLM). The computer-implemented method may include calculating the first loss or the second loss by feeding the question and the response of the set of instructions through a tokenizer and a large language model (LLM).

One or more images of the set of images may be associated with one or more tasks. One or more of the tasks may be an optical character recognition (OCR) recognition task, a recurring expression detection task, or a conversation capability task. The computer-implemented method may include calculating the first loss and the second loss by feeding an image of the reference set of images through a vision encoder, a projector, and a large language model (LLM). The computer-implemented method may include calculating the first loss or the second loss by feeding the question and the response of the set of instructions through a tokenizer and a large language model (LLM).

According to one aspect, a system for instruction tuning may include a processor and a memory. The memory may store one or more instructions. The processor may execute one or more of the instructions stored on the memory to perform one or more acts, actions, and/or steps. The processor may generate a set of instructions for a reference set of images selected from a set of images based on one or more task specific instruction generation protocols. The processor may generate one or more task importance weights for the reference set of images based on the set of instructions and the reference set of images and a ratio of a first loss of a first loss function associated with a response and an image from reference set of images and a second loss of a second loss function associated with the response, a question, and the image from reference set of images. The processor may generate a set of instructions for a remaining set of images from the set of images based on one or more of the task importance weights, k-means clustering, and neighbor centrality from a cluster of the k-means clustering. The processor may fine tune a large vision language model (LVLM) based on the set of instructions for the remaining set of images.

One or more images of the set of images may be associated with one or more tasks. One or more of the tasks may be an optical character recognition (OCR) recognition task, a recurring expression detection task, or a conversation capability task. The processor may calculate the first loss and the second loss by feeding an image of the reference set of images through a vision encoder, a projector, and a large language model (LLM). The processor may calculate the first loss or the second loss by feeding the question and the response of the set of instructions through a tokenizer and a large language model (LLM).

### BRIEF DESCRIPTION OF THE DRAWINGS

FIG. 1 is an exemplary component diagram of a system for instruction tuning, according to one aspect.

FIG. 2 is an exemplary flow diagram of a computer-implemented method for instruction tuning, according to one aspect.

FIG. 3 is an exemplary diagram in association with visual instruction tuning, according to one aspect.

FIG. 4 is an exemplary diagram in association with visual instruction tuning, according to one aspect.

FIG. 5 is an exemplary diagram in association with visual instruction tuning, according to one aspect.

FIG. 6 is an exemplary diagram in association with visual instruction tuning, according to one aspect.

FIG. 7 is an illustration of an example computing environment where one or more of the provisions set forth herein are implemented, according to one aspect.

FIG. 8 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

Visual instruction tuning (VIT) for large vision-language models (LVLMs) generally requires training on expansive datasets of image-instruction pairs, which may be costly. As discussed herein, VIT data selection may be performed by selecting a small subset of high-quality image-instruction pairs, reducing VIT runtime while maintaining performance comparable to full-scale training. However, a major challenge often overlooked is that generating instructions from unlabeled images for VIT may be computationally expensive. Most existing VIT datasets rely heavily on human annotations or paid services like Generative Pre-trained Transformer (GPT), which limits users with constrained resources from creating VIT datasets for custom applications. To address this, systems and methods for instruction tuning (e.g., herein Pre-Instruction Data Selection (PreSel)), a more practical data selection paradigm that directly selects the most beneficial unlabeled images and generates instructions only for the selected images is provided herein. The PreSel instruction tuning described herein may estimate the relative importance of each vision task within VIT datasets to derive task-wise sampling budgets. The PreSel instruction tuning may then cluster image features within each task, selecting the most representative images with the budget. This approach provides the benefit or advantages of reducing computational complexity and computational overhead for both instruction generation during VIT data formation and LVLM fine-tuning.

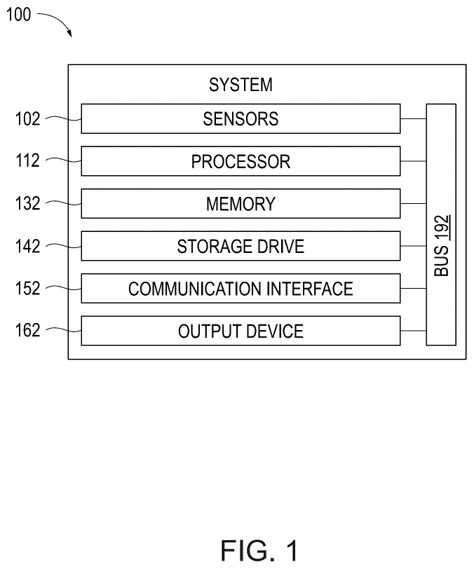

FIG. 1 is an exemplary component diagram of a system 100 for instruction tuning, according to one aspect. The system 100 for instruction tuning may include sensors 102 and a processor 112. The sensors 102 may receive inputs, such as one or more of (I, Q, R), where I represents an image, Q represents a textual question from a human, and R represents a response (from GPT). The processor 112 may include an encoder, a projector, and a tokenizer. The system 100 for instruction tuning may include a memory 132 and a storage drive 142. The storage drive 142 may store a large language model (LLM). The LLM may be received via a communication interface 152 and be downloaded over a network or a cloud. The system 100 for instruction tuning may include an output device 162 and a bus 192.

The memory 132 may store one or more instructions. The processor 112 may execute one or more of the instructions stored on the memory 132 to perform one or more acts, actions, and/or steps. The bus 192 may operably connect one or more components (e.g., the processor 112, the memory 132, the storage drive 142, the communication interface 152, the output device 162, etc.) of the system 100 for instruction tuning and enable computer communication therebetween.

The processor 112 may generate a set of instructions for a reference set of images selected from a set of images based on one or more task specific instruction generation protocols. Each instruction for the set of instructions may include a corresponding question and a corresponding response. One or more images of the set of images may be associated with one or more tasks. One or more of the tasks may be an optical character recognition (OCR) recognition task, a recurring expression detection task, or a conversation capability task.

The processor 112 may generate one or more task importance weights for the reference set of images based on the set of instructions and the reference set of images and a ratio of a first loss of a first loss function associated with a response and an image from reference set of images and a second loss of a second loss function associated with the response, a question, and the image from reference set of images. The processor 112 may calculate the first loss and the second loss by feeding an image of the reference set of images through a vision encoder, a projector, and a large language model (LLM). The processor 112 may calculate the first loss or the second loss by feeding the question and the response of the set of instructions through a tokenizer and a large language model (LLM). The processor 112 may generate one or more of the task importance weights for the reference set of images based on task-wise averaging the ratio of the first loss and the second loss.

The processor 112 may generate a set of instructions for a remaining set of images from the set of images based on one or more of the task importance weights, k-means clustering, and neighbor centrality from a cluster of the k-means clustering. The processor 112 may perform k-means clustering based on one or more of the task importance weights and one or more visual features from the remaining set of images. The processor 112 may generate one or more of the visual features for the remaining set of images based on an encoder. The set of instructions for a remaining set of images may be stored on the storage drive 142 or output on the output device 162.

The processor 112 may perform fine tuning on a large vision language model (LVLM) based on the set of instructions for the remaining set of images.

### Problem Formulation

Consider a large pool of unlabeled images [symbol] assembled from various datasets to construct a VIT dataset with M distinct vision tasks

$${\{ {T}_{i} \}}_{i = 1}^{M} ,$$

where

$$𝒟 = {U}_{i = 1}^{M} {T}_{i} .$$

The processor 112 may denote the number of samples in [symbol] as | [symbol] |. Examples of vision tasks include visual question answering (VQA), optical character recognition (OCR), etc. Each task Tᵢ may include a set of unlabeled images

$${T}_{i} = {\{ {I}_{a}^{i} \}}_{a = 1}^{\vert {T}_{i} \vert} .$$

According to one aspect, tasks may overlap in images, e.g., Tᵢ∩Tⱼ≠Ø for some i≠j. For an unlabeled image I from task Tᵢ, the corresponding textual instruction Y may be generated as Y=Fᵢ(I), where Fᵢ is not a straightforward mathematical function; rather, it is a costly, task-specific procedure, potentially involving resources such as the GPT API or human annotators who label images with instructions based on defined guidelines.

The goal of pre-instruction data selection may be to select a small subset of highly beneficial unlabeled images [symbol] _{S}⊂ [symbol] , where | [symbol] _{S}|<<| [symbol] |, and then the pre-instruction data selection may only acquire instructions for this small subset. Fine-tuning an LVLM on the resulting image-instruction pairs,

$${\{ ( {I}_{a} , {Y}_{a} ) \}}_{a = 1}^{\vert {𝒟}_{s} \vert} ,$$

may maximally improve the LVLM's instruction-following capabilities and achieve performance comparable to full-scale fine-tuning on [symbol] with complete instructions:

$${\{ ( {I}_{a} , {Y}_{a} ) \}}_{a = 1}^{\vert 𝒟 \vert} .$$

One difference between the pre-instruction data selection paradigm and existing VIT data selection methods is that previous methods assume access to instructions of all images

$$( e . g . , {\{ ( {I}_{a} , {Y}_{a} ) \}}_{a = 1}^{\vert 𝒟 \vert} ,$$

while the pre-instruction data selection described herein solely relies on unlabeled images

$${\{ {I}_{a} \}}_{a = 1}^{\vert 𝒟 \vert}$$

for selecting [symbol] _{S}. Hence, this paradigm provided the benefit of enabling efficiency in both training and instruction generation.

According to one aspect, a Task-Importance Estimation mechanism (e.g., implemented via the processor 112) may obtain the optimal proportion of each task Tᵢ in [symbol] _{S}. To achieve this, the processor 112 may first randomly select a small reference set of images [symbol] _{ref} ⊂ [symbol] , where | [symbol] _{ref}|<<| [symbol] _{S}|<<| [symbol] |, and acquire their corresponding instructions,

$${\{ ( {I}_{a} , {Y}_{a} ) \}}_{a = 1}^{\vert {𝒟}_{ref} \vert} .$$

Each instruction Yₐ may be decomposed into questions Qₐ and responses Rₐ, which are used to compute an Instruction Relevance Score (IRS) for the samples in D_{ref}. The average IRS over images in each task Tᵢ determines the relative proportions of these tasks in [symbol] _{S}, termed w(Tᵢ). Next, the processor 112 may employ a lightweight vision encoder (e.g., DINOv2), to extract visual features for the remaining unlabeled images and cluster them in each task. Finally, given the derived task proportion w(Tᵢ), the most representative images from each cluster are selected via a Neighbor Centrality (NC) score.

### Task Importance Estimation

Determining an appropriate proportion of samples from each task for the final selected subset [symbol] _{S} may be desired. Simply relying on the number of images available per task to set these proportions may lead to suboptimal performance, as tasks often differ in their levels of redundancy. Also, some tasks may be effectively learned through training on related tasks, making direct sampling from them less important.

The processor 112 may fine-tune an LVLM on image-instruction pairs in the small reference set D_{ref}, which comprises only a small fraction (e.g., around 5% or between 5% and 20%) of the entire VIT dataset [symbol] . This initial fine-tuning, conducted for one epoch, equips the LVLM with basic instruction-following abilities. The processor 112 may refer to this fine-tuned model as the reference model. The processor 112 may extend the loss-based idea to address the more complicated multimodal scenario and leverage the loss predictions of the reference model on D_{ref} to define the Instruction Relevance Score (IRS) for estimating task importance.

Each VIT example in D_{ref} may be represented as a triplet (I, Q, R), where I represents the image, Q the textual question (from a human), and R the response (from GPT). Q and R may extend over multiple interaction rounds. The IRS may be calculated by comparing the reference model's next-token cross-entropy (CE) loss with and without the Q tokens as part of the input using the processor 112. This score evaluates how much the provided Q contributes to generating the ground-truth response R. Formally, the next-token cross-entropy (CE) loss for R given the tokens of I and Q as context is as follows:

$${ℒ}_{R \vert Q , I} = - \frac{1}{\vert {t}^{R} \vert} {\sum }_{j = 1}^{\vert {t}^{R} \vert} log {P}_{θ} ( {t}_{j}^{R} \vert I , Q , {t}_{< j}^{R} ) \qquad ( 1 )$$

where t^{R} is the tokenized R with |t^{R}| tokens, and

$${t}_{< j}^{R}$$

is the sequence of tokens preceding the j-th token in R. P_{θ} denotes the predicted probability distribution of the reference model, parameterized by θ. The processor 112 may then calculate the loss without the Q given as context:

$${ℒ}_{R \vert I} = \frac{1}{\vert {t}^{R} \vert} {\sum }_{j = 1}^{\vert {t}^{R} \vert} log {P}_{θ} ( {t}_{j}^{R} \vert I , {t}_{< j}^{R} ) \qquad ( 2 )$$

where the response is only conditioned on the image context. The IRS may be formulated as the ratio of these two losses as follows:

$$IRS = \frac{{L}_{R \vert Q , I}}{{L}_{R \vert I}} \qquad ( 3 )$$

A higher IRS may indicate that adding the Q context to I does not assist in refining the model for easier generation of R. In contrast, a lower IRS may indicate that the model's confusion regarding R is reduced when Q is provided as input, emphasizing the necessity of Q for VIT. The processor 112 may then compute the average IRS over all samples in D_{ref} that belong to task Tᵢ as follows:

$$s ( {T}_{i} ) = \frac{1}{\vert {𝒟}_{ref}^{i} \vert} {\sum }_{I ∈ {T}_{i}} IRS ( I , Y ) \qquad ( 4 )$$

where

$$\vert {𝒟}_{ref}^{i} \vert$$

denotes the number of samples in D_{ref} that belong to Tᵢ. Based on the definition of IRS, a lower s(Tᵢ) indicates a higher importance of Tᵢ. The final relative proportion of each task within D_{S} is defined as:

$$w ( {T}_{i} ) = \frac{exp ( - s ( {T}_{i} ) / τ )}{{\sum }_{j = 1}^{M} exp ( - s ( {T}_{j} ) / τ )} \qquad ( 5 )$$

where the processor 112 may set the temperature value

$$τ = \frac{1}{\sqrt{M}} .$$

### Task-Wise Cluster-Based Selection

After determining the relative proportion of each task using the reference set, the processor 112 may focus on selecting informative unlabeled images within each task for instruction generation. For the unlabeled images in task Tᵢ, the processor 112 may first extract their visual features using the pre-trained DINOv2 model, a lightweight vision encoder. Given an input image I∈Tᵢ, the processor 112 may obtain the feature vector v, from the last transformer layer's [CLS] token after Layer Normalization (LN) as:

$${v}_{I} = LN ( {h}_{L}^{[ CLS ]} ) ∈ {ℝ}^{𝒟} \qquad ( 6 )$$

$$where {h}_{L}^{[ CLS ]}$$

denotes the [CLS] token output from the last transformer layer L, and D is the feature dimension. The processor 112 may then cluster these obtained vᵢ features of task Tᵢ into C clusters

$${\{ {A}_{c}^{i} \}}_{c = 1}^{C}$$

using a K-means algorithm, where the processor 112 may set

$$c = \frac{\vert {T}_{i} \vert}{100} .$$

To select samples from the c-th cluster

$${A}_{c}^{i}$$

within Tᵢ, the processor 112 may consider both its relative size

$$\vert {A}_{c}^{i} \vert$$

and the importance weight w(Tᵢ) of task Tᵢ. Specifically, the processor 112 may select:

$${n}_{c} = ⌊ \frac{w ( {T}_{i} ) \cdot \vert {A}_{c}^{i} \vert}{\vert {T}_{i} \vert} \cdot \vert {𝒟}_{s} \vert ⌋ \qquad ( 7 )$$

images from cluster

$${A}_{c}^{i} .$$

This approach ensures a diverse selection of images within each cluster, taking into account its size and the overall importance of the corresponding task.

### Intra-Cluster Selection

Within each cluster, the processor 112 may select the n_{c} most representative images based on the Neighbor Centrality (NC) score, defined as:

$${s}_{n c} ( I ) = \frac{1}{k} \cdot {\sum }_{{I}_{a} ∈ kNN ( I )} sim ( {v}_{I} , {v}_{{I}_{a}} ) \qquad ( 8 )$$

Here the processor 112 may denote the k-nearest neighbors of a given image/in feature space as kNN(I), and sim (⋅,⋅) is the cosine similarity. A higher s_{nc} may indicate that the image is closely situated to its neighbors, implying it is more likely to be a representative sample rather than an outlier.

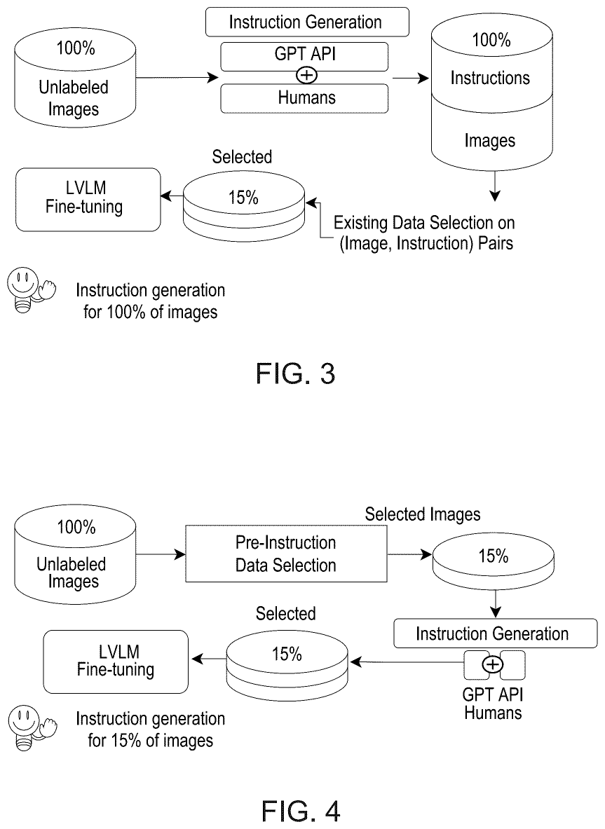

Finally, the collection of selected images from all tasks may be assembled as [symbol] _{S}. The processor 112 may utilize resources to generate instructions only for images in [symbol] _{S}, which are then used to fine-tune the LVLM, as seen in FIG. 3.

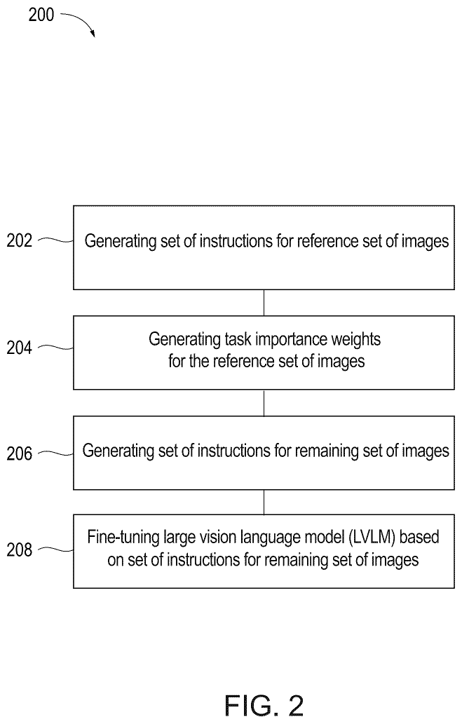

FIG. 2 is an exemplary flow diagram of a computer-implemented method for instruction tuning, according to one aspect. The computer-implemented method may include generating 202 a set of instructions for a reference set of images selected from a set of images based on one or more task specific instruction generation protocols, generating 204 one or more task importance weights for the reference set of images based on the set of instructions and the reference set of images and a ratio of a first loss of a first loss function associated with a response and an image from reference set of images and a second loss of a second loss function associated with the response, a question, and the image from reference set of images, and generating 206 a set of instructions for a remaining set of images from the set of images based on one or more of the task importance weights, k-means clustering, and neighbor centrality from a cluster of the k-means clustering. Additionally, the computer-implemented method for instruction tuning may include fine-tuning 208 a large vision language model (LVLM) based on the set of instructions for the remaining set of images.

FIG. 3 is an exemplary diagram in association with visual instruction tuning, according to one aspect. Generally, existing visual instruction tuning (VIT) data selection methods assume access to well-prepared VIT datasets in which all the images are already annotated with instructions by costly resources, such as Generative Pre-trained Transformer (GPT) and human labor. These methods require information on both images and their instructions.

FIG. 4 is an exemplary diagram in association with visual instruction tuning, according to one aspect. The instruction tuning described herein performs selection directly on unlabeled images and utilizes resources to generate instructions exclusively for the selected images (e.g., reference set of images). Hence, not only is faster fine-tuning enabled, but this also significantly reduces instruction generation costs (e.g., 5% or 15% for the reference set of images).

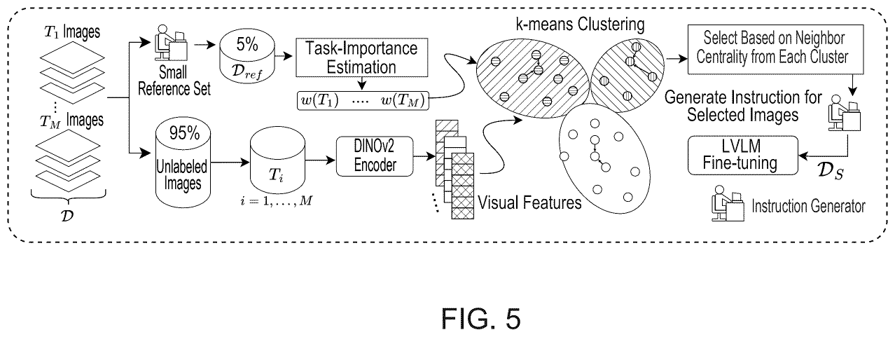

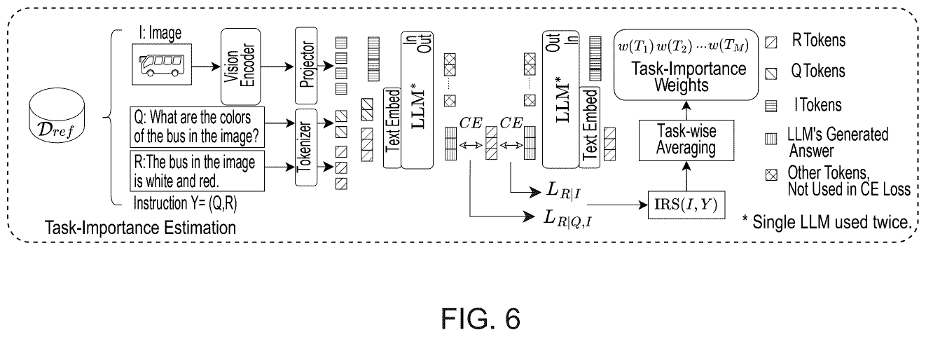

FIGS. 5-6 are exemplary diagrams in association with visual instruction tuning, according to one aspect. Systems and methods for instruction tuning (e.g., Pre-Instruction Data Selection (PreSel)) are provided herein. PreSel is an efficient Pre-Instruction Data Selection approach for Visual Instruction Tuning (VIT). Given a large pool of unlabeled images D from various tasks, PreSel may first estimate the importance of each task Tᵢ via a small reference set D_{ref} with instructions generated. Each instruction may be split into a question (Q) and a response (R) to compute the Instruction Relevance Score (IRS), which determines task proportions ω(Tᵢ) in the final selected subset D_{S}. Given the derived task proportions, PreSel may then use a vision encoder to extract features from the remaining unlabeled images, perform clustering within each task, and select representative images using a Neighbor Centrality (NC) score. The collection of selected images from all tasks is assembled as D_{S}.

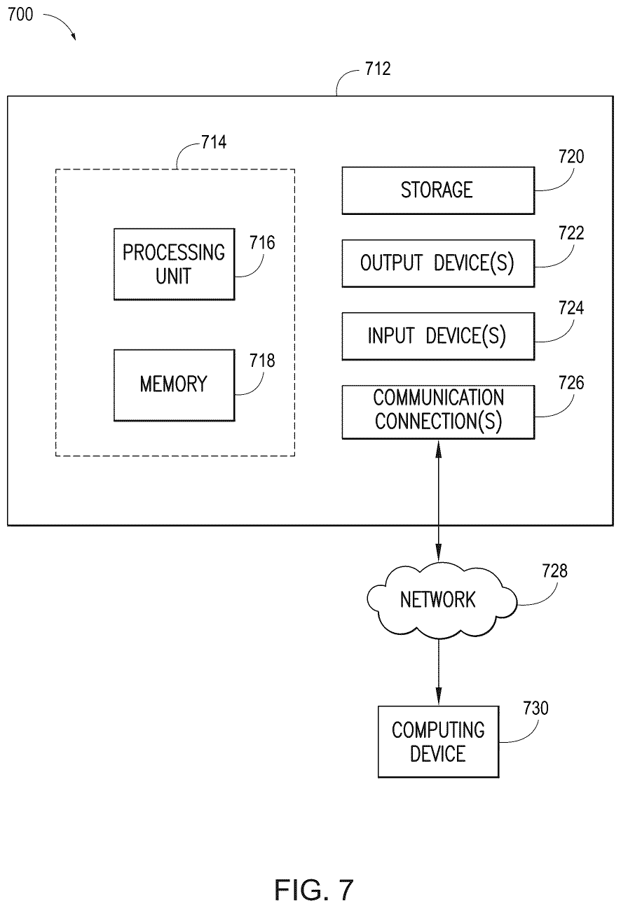

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions is combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

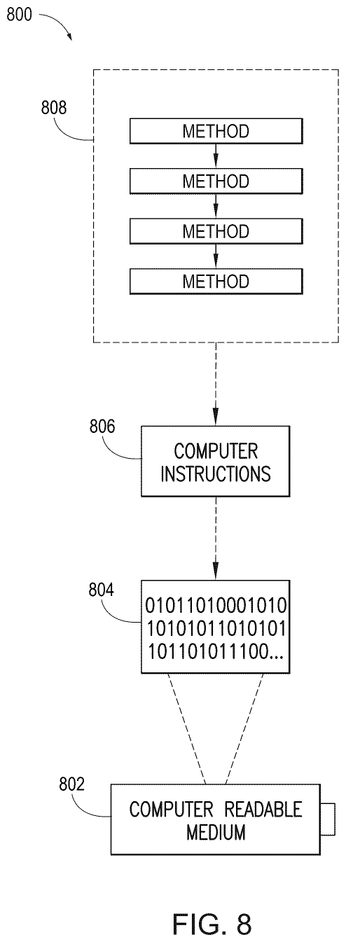

Still another aspect involves a computer-readable medium including processor-executable instructions configured to implement one aspect of the techniques presented herein. An aspect of a computer-readable medium or a computer-readable device devised in these ways is illustrated in FIG. 8, where an implementation 800 includes a computer-readable medium 802, such as a CD-R, DVD-R, flash drive, a platter of a hard disk drive, etc., on which is encoded computer-readable data 804. This encoded computer-readable data 804, such as binary data including a plurality of zero's and one's as shown in 804, in turn includes a set of processor-executable computer instructions 806 configured to operate according to one or more of the principles set forth herein. In this implementation 800, the processor-executable computer instructions 806 may be configured to perform a method 808, such as the computer-implemented method 200 for instruction tuning of FIG. 2. In another aspect, the processor-executable computer instructions 806 may be configured to implement a system, such as the system 100 for instruction tuning of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for instruction tuning, comprising:
a memory storing one or more instructions; and
a processor executing one or more of the instructions stored on the memory to perform:
generating a set of instructions for a reference set of images selected from a set of images based on one or more task specific instruction generation protocols;
generating one or more task importance weights for the reference set of images based on the set of instructions and the reference set of images and a ratio of a first loss of a first loss function associated with a response and an image from reference set of images and a second loss of a second loss function associated with the response, a question, and the image from reference set of images; and
generating a set of instructions for a remaining set of images from the set of images based on one or more of the task importance weights, k-means clustering, and neighbor centrality from a cluster of the k-means clustering.

2. The system for instruction tuning of claim 1, wherein one or more images of the set of images is associated with one or more tasks.

3. The system for instruction tuning of claim 2, wherein one or more of the tasks is an optical character recognition (OCR) recognition task, a recurring expression detection task, or a conversation capability task.

4. The system for instruction tuning of claim 1, wherein the processor calculates the first loss and the second loss by feeding an image of the reference set of images through a vision encoder, a projector, and a large language model (LLM).

5. The system for instruction tuning of claim 1, wherein the processor calculates the first loss or the second loss by feeding the question and the response of the set of instructions through a tokenizer and a large language model (LLM).

6. The system for instruction tuning of claim 1, wherein the processor generates one or more of the task importance weights for the reference set of images based on task-wise averaging the ratio of the first loss and the second loss.

7. The system for instruction tuning of claim 1, wherein the processor performs k-means clustering based on one or more of the task importance weights and one or more visual features from the remaining set of images.

8. The system for instruction tuning of claim 7, wherein the processor generates one or more of the visual features for the remaining set of images based on an encoder.

9. The system for instruction tuning of claim 1, wherein each instruction for the set of instructions includes a corresponding question and a corresponding response.

10. The system for instruction tuning of claim 1, wherein the processor performs fine-tuning on a large vision language model (LVLM) based on the set of instructions for the remaining set of images.

11. A computer-implemented method for instruction tuning, comprising:
generating a set of instructions for a reference set of images selected from a set of images based on one or more task specific instruction generation protocols;
generating one or more task importance weights for the reference set of images based on the set of instructions and the reference set of images and a ratio of a first loss of a first loss function associated with a response and an image from reference set of images and a second loss of a second loss function associated with the response, a question, and the image from reference set of images; and
generating a set of instructions for a remaining set of images from the set of images based on one or more of the task importance weights, k-means clustering, and neighbor centrality from a cluster of the k-means clustering.

12. The computer-implemented method for instruction tuning of claim 11, wherein one or more images of the set of images is associated with one or more tasks.

13. The computer-implemented method for instruction tuning of claim 12, wherein one or more of the tasks is an optical character recognition (OCR) recognition task, a recurring expression detection task, or a conversation capability task.

14. The computer-implemented method for instruction tuning of claim 11, comprising calculating the first loss and the second loss by feeding an image of the reference set of images through a vision encoder, a projector, and a large language model (LLM).

15. The computer-implemented method for instruction tuning of claim 11, comprising calculating the first loss or the second loss by feeding the question and the response of the set of instructions through a tokenizer and a large language model (LLM).

16. A system for instruction tuning, comprising:
a memory storing one or more instructions; and
a processor executing one or more of the instructions stored on the memory to perform:
generating a set of instructions for a reference set of images selected from a set of images based on one or more task specific instruction generation protocols;
generating one or more task importance weights for the reference set of images based on the set of instructions and the reference set of images and a ratio of a first loss of a first loss function associated with a response and an image from reference set of images and a second loss of a second loss function associated with the response, a question, and the image from reference set of images;
generating a set of instructions for a remaining set of images from the set of images based on one or more of the task importance weights, k-means clustering, and neighbor centrality from a cluster of the k-means clustering; and
fine-tuning a large vision language model (LVLM) based on the set of instructions for the remaining set of images.

17. The system for instruction tuning of claim 16, wherein one or more images of the set of images is associated with one or more tasks.

18. The system for instruction tuning of claim 17, wherein one or more of the tasks is an optical character recognition (OCR) recognition task, a recurring expression detection task, or a conversation capability task.

19. The system for instruction tuning of claim 16, wherein the processor calculates the first loss and the second loss by feeding an image of the reference set of images through a vision encoder, a projector, and a large language model (LLM).

20. The system for instruction tuning of claim 16, wherein the processor calculates the first loss or the second loss by feeding the question and the response of the set of instructions through a tokenizer and a large language model (LLM).
